(19) United States
(12) Patent Application Publication
(10) Pub. No.: US 2010/0313790 A1
(43) Pub. Date: Dec. 16, 2010

(54) Lightweight concrete composition containing soybean protein as a eco-friendly foaming agent

(76) Inventors: Henry Gembala, Deerfield Beach, FL (US); Crystal Gembala, Deerfield Beach, FL (US)

Correspondence Address: ROBERT M. DOWNEY, P.A., 6751 N. FEDERAL HWY., SUITE 300, BOCA RATON, FL, 33487, US

(21) Appl. No.: 12/802,879

(22) Filed: Jun. 16, 2010

Related U.S. Application Data
(60) Provisional application No. 61/268,841, filed on Jun. 16, 2009.

(51) Int. Cl. C04B 24/14

(52) U.S. Cl. 106/646

(57) ABSTRACT

A lightweight composition is formed by combining and mixing Portland cement or other cementitous material with foam in order to create air pockets throughout the cementitious material. A foaming agent containing primarily or entirely soybean protein in liquid form is introduced with a pressurized flow of air and water in order to produce the foam.

### BACKGROUND OF THE INVENTION

This non-provisional application is based on provisional patent application Ser. No. 61/268,841 filed on Jun. 16, 2009.

### FIELD OF THE INVENTION

This invention relates to concrete construction materials and, more particularly, to a lightweight concrete composition having good compressive strength and insulating properties formed with a cementitious material combined with foam generated from a soybean protein mixture.

### DISCUSSION OF THE RELATED ART

Various insulating materials are employed to reduce the heat conduction between two separated spaces. Unfortunately, many materials which meet the criterion of being an insulating material also suffer from extremely low compressive strengths. Even materials which, at ambient temperature, demonstrate a reasonably high insulation and compressive strength often lose their compressive strength when the temperature is varied too greatly (i.e. several hundred degrees Fahrenheit). To address this problem, the concept of lightweight concretes as insulating materials has gained popularity. Such materials are able to insulate effectively with relatively no loss in compressive strength. Lightweight concrete is used extensively in the construction of buildings, and particularly in the installation of roof decks and related roof systems. When installing a roof deck on a building structure, lightweight concrete is disbursed, in a slurry coat, to form a topping layer of insulation over underlying roofing materials. Lightweight concrete typically consists of a combination of Portland cement, one or more foaming agents, water and possibly other chemical agents.

The primary disadvantage of current lightweight concretes is the use of chemical agents which are not eco-friendly. Most commonly these chemical agents are used as part of a composition for the one or more foaming agents used in the creation of the lightweight concrete. Due to the increasing demand for eco-friendly resources in the interest of sustainability, it is imperative that materials, particularly materials used in the construction of buildings, are entirely “green.”

In view of the shortcomings associated with current methods of production of lightweight concrete, there remains a need for a foaming agent that is entirely eco-friendly and natural and which is capable of providing the same quality or greater performance compared to existing chemically-based foaming agents. Protein solutions are ideal for use as a foaming agent in the manufacture of lightweight concrete. Soybeans provide a sustainable source of protein that is all-natural environmentally safe. Moreover, the high concentration of protein derived from soybeans provides for a highly effective foaming agent that is superior to existing foaming agents that use animal protein or synthetic protein.

### OBJECTS AND ADVANTAGES OF THE INVENTION

Considering the foregoing, it is a primary object of the present invention to provide an eco-friendly foaming agent comprised of soybean protein for use in the production of lightweight concrete.

It is a further object of the present invention to provide a 100% natural and sustainable source of protein in a foaming agent used for the production of lightweight concrete.

It is still a further object of the present invention to provide a lightweight concrete composition containing soybean protein as a foaming agent, thereby allowing the lightweight concrete composition to be used in the construction of buildings classified as “green buildings.”

It is still a further object of the present invention to provide a foaming agent for use in the production of lightweight concrete, wherein the foaming agent contains primarily or entirely soybean protein, thereby creating a new market for soybeans.

It is still a further object of the present invention to provide a foaming agent for use in the production of lightweight concrete containing primarily or entirely soybean protein, thereby creating an increased demand for soybeans to the benefit of farmers.

It is still a further object of the present invention to provide a lightweight concrete composition that can be classified as a “green product.”

These and other objects and advantages of the present invention are more readily apparent with reference to the detailed description.

### SUMMARY OF THE INVENTION

The present invention is directed to a composition for a lightweight concrete which incorporates a liquid foaming agent composed entirely of soybean protein which is 100% natural and eco-friendly. The eco-friendly lightweight concrete composition comprises Portland cement, water and the soybean protein foaming agent, and no chemical agents. The lightweight concrete composition is formed by a combining and mixing the Portland cement or other cementitious material with foam in order to create air pockets throughout the cementitious material. The foam is generated by introducing the lightweight foaming agent into a pressurized flow of water and air. Use of soybeans provides for a sustainable source of highly concentrated protein in a foaming agent that will not harm the environment.

### DETAILED DESCRIPTION OF THE INVENTION

A lightweight concrete composition with insulating properties is particularly adapted for use as a roof deck substrate or floor underlayment in the construction industry. The lightweight concrete composition comprises Portland cement, water, and a foaming agent. Other cementitous materials may be used in lieu of Portland cement and are fully contemplated for use in the present invention. The foaming agent is comprised of soybean protein which is 100% natural and 100% eco-friendly. Moreover, the entire composition of the lightweight concrete is 100% eco-friendly. More specifically, the composition for lightweight concrete has no negative impact on the natural eco-system and can be qualified as a “green product”.

The composition may be manufactured using any commonly used apparatus for lightweight concrete manufacturing and may be applied using well known application methods in the construction industry where lightweight concrete is typically used.

The lightweight concrete composition of the present invention is formed by combining and mixing the Portland cement, or other cementitious material, with foam in order to create air pockets throughout the cementitious material. The foam is generated by introducing the foaming agent into a pressurized flow of air and water. The flow of foaming agent, mixed with the flow of water and air, may be directed through a carburetor or other apparatus in order to agitate the foaming agent mixture and enhance the production of foam which is then directed to a mixer for mixing and combining with the cementitious material.

While the present invention has been shown and described in accordance with a preferred and practical embodiment thereof, it is recognized that departures from the instant disclosure are contemplated within the spirit and scope of the present invention, which is not to be limited, except as defined in the following claims as interpreted under the Doctrine of Equivalents.

What is claimed is:

1. A lightweight concrete composition comprising:
a cementitious material;
foam combined and mixed with the cementitious material, and the foam comprising:
soybean protein as a foaming agent;
water; and
air.

2. The lightweight concrete composition as recited in claim 1 wherein the cementitious material is Portland material.

3. The lightweight concrete composition as recited in claim 1 wherein the soybean protein foaming agent is a liquid solution.
